(19) United States
(12) Patent Application Publication
(10) Pub. No.: US 2009/0004428 A1
(43) Pub. Date: Jan. 1, 2009

(54) Moisture-permeable, waterproof and windproof laminated sheet, interlining using the same, and garment containing the interlining

(76) Inventors: Andreas Renken, Geneva (CH); Franz Spitznagel, Marktheidenfeld (DE); Guillaume Doy, Premanon (FR); Klaus Walter Bender, Neustrasse (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/150,173

(22) Filed: Apr. 24, 2008

Related U.S. Application Data
(60) Provisional application No. 60/926,863, filed on Apr. 30, 2007.

(51) Int. Cl. B32B 3/30

(52) U.S. Cl. 428/76; 264/279

(57) ABSTRACT

The invention relates to molded thermoplastic articles consisting of: a thermoplastic resin overmolded on a support screen, which support screen has indentations/protuberances.

### CROSS REFERENCE TO RELATED APPLICATIONS

This application claims the benefit of U.S. Provisional Application No. 60/926,863, filed Apr. 30, 2007.

### FIELD OF INVENTION

The present invention relates to the field of reinforced thermoplastic polymers, in particular, support screen reinforced thermoplastics.

### BACKGROUND OF THE INVENTION

The replacement of metal parts by plastic is increasingly popular because this contributes to reducing the weight of such articles, which is particularly important for use in automotive and industrial applications.

Such plastics often require reinforcement to have mechanical properties similar to metal. With the aim of increasing the strength and/or the resilience of an article, metal or plastic supports are often added to the structure of the article.

WO 2005/090048 discloses the use of a mesh which is inserted and clamped in a mold prior to injection. During injection, the polymer entering the mold tends to push the mesh to the inner surface of the mold cavity, with the result that after solidification of the polymer, the mesh sits on the surface of the finished molded article. This leads to an unattractive surface and a decreased resistance to warpage.

EP0447223 discloses molded articles of fiber reinforced thermoplastic resins. A multi-step procedure has been described, including first the preparation of a sheet preform made of a fiber reinforced composite, then the preparation of an intermediate sheet having a mesh over the preform and finally, injection molding over this intermediate sheet. This technology requires a three-step process, making it expensive and time-consuming.

DE19948664 discloses a two step process including first the placement of a mesh in a mold and its overmoulding on one side, then opening the mold and overmoulding on the opposite side. This type of sandwich structure suffers the disadvantage that the overmoulding of a polymer on itself or on another one can be problematic leading, for example, to adhesion problems that could lead to the delaminating of the first part (which contains the mesh) from the second part.

EP1577077 describes a steel mesh reinforced plastic composite further comprising metal and/or plastic pins that are inserted in the mesh to keep it in the position in the mold during injection molding. This technology requires assembly of the mesh and pins, making it expensive and time-consuming. Positioning the pins in the mold can be problematic.

There is a current need to find a way to improve the strength and/or resilience of a thermoplastic molded article by adding a reinforcing structure while yielding good surface characteristics, and low warpage of the final molded article.

### SUMMARY OF THE INVENTION

The inventors have surprisingly found that articles made of thermoplastic resins overmolded on a support screen, which support screen has indentations/protuberances show improved strength and/or resilience as well as good surface characteristics, and low warpage of the final molded article.

In a first aspect, the present invention provides a molded thermoplastic article consisting of: a thermoplastic resin overmolded on a support screen, which support screen has indentations/protuberances.

In a second aspect, the present invention provides a method for manufacturing a reinforced thermoplastic article.

### DETAILED DESCRIPTION OF THE INVENTION

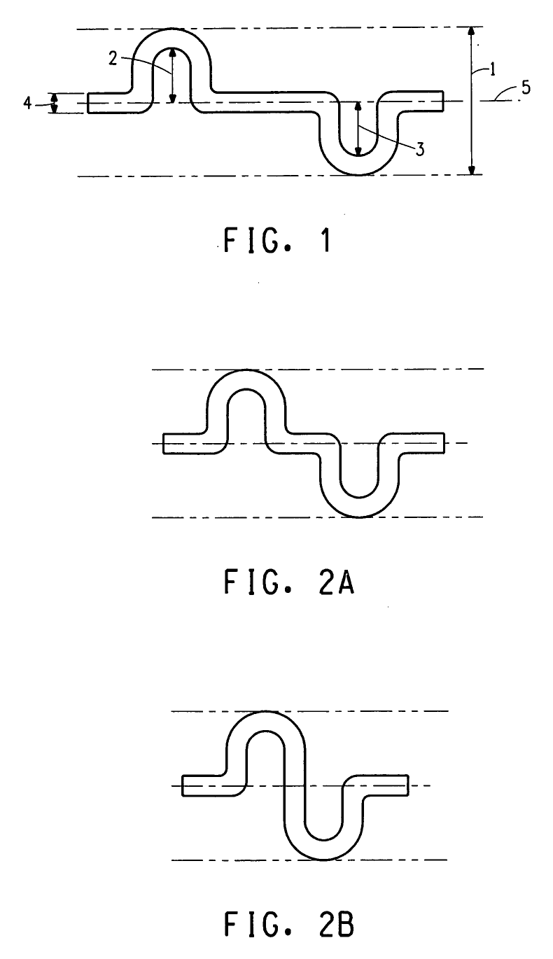

FIG. 1 is a cross-sectional view of a molded thermoplastic article consisting of a thermoplastic resin that is overmolded on a support screen, which support screen has indentations. 1 designates the overall thickness of the support screen, 2 designates the depth of indentation on the top surface of the support screen, 3 designates the depth of indentation on the bottom surface of the support screen, 4 designates the thickness of the support screen itself and 5 designates the medial plan of the support screen embedded in the thermoplastic resin.

FIG. 2. FIG. 2A is a cross-sectional view of a molded thermoplastic article consisting of a thermoplastic resin that is overmolded on a support screen, which support screen has indentations/protuberances, and wherein the indentations/protuberances are spaced apart. FIG. 2B is a cross-sectional view of a molded thermoplastic article consisting of a thermoplastic resin that is overmolded on a support screen, which support screen has indentations/protuberances, and wherein the indentations/protuberances are contiguous.

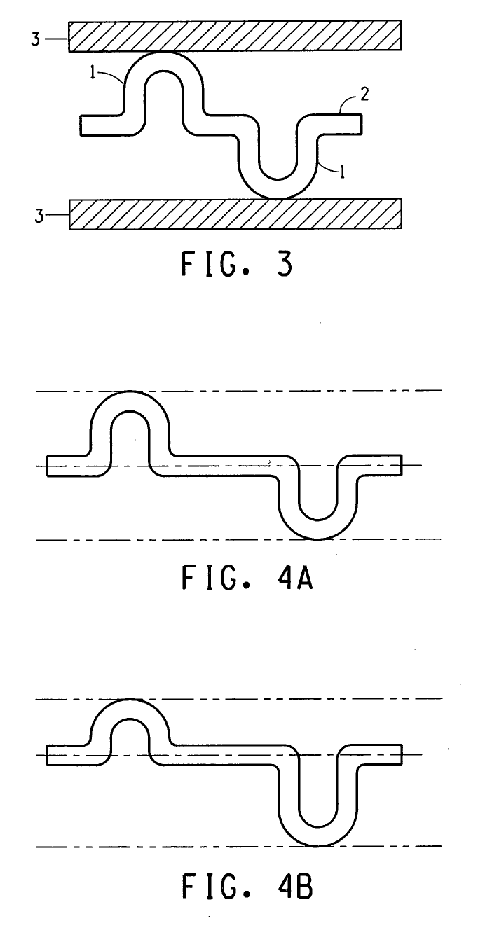

FIG. 3. a cross-sectional view of a support screen, which support screen has indentations/protuberances and which is placed in a mold cavity. 1 designates indentations/protuberances, 2 designates the support screen and 3 designates the side of the mold cavity.

FIG. 4. FIG. 4A is a cross-sectional view of a molded thermoplastic article consisting of a thermoplastic resin that is overmolded on a support screen, which support screen has indentations/protuberances, and wherein the depth of indentations/protuberances is the same. FIG. 4B is a cross-sectional view of a molded thermoplastic article consisting of a thermoplastic resin that is overmolded on a support screen, which support screen has indentations/protuberances, and wherein the depth of indentations is not the same as the depth of protuberances.

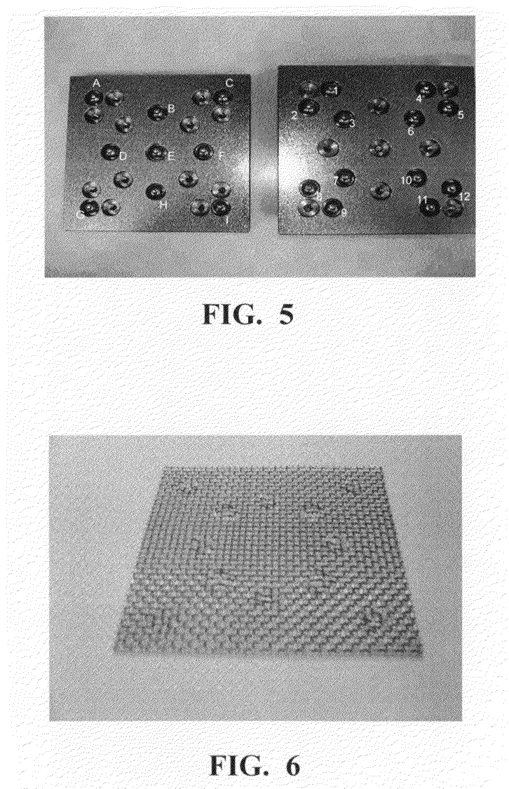

FIG. 5. is a picture of a stamp plate that can be used to do indentations/protuberances.

FIG. 6. is a picture of a steel mesh comprising indentations/protuberances.

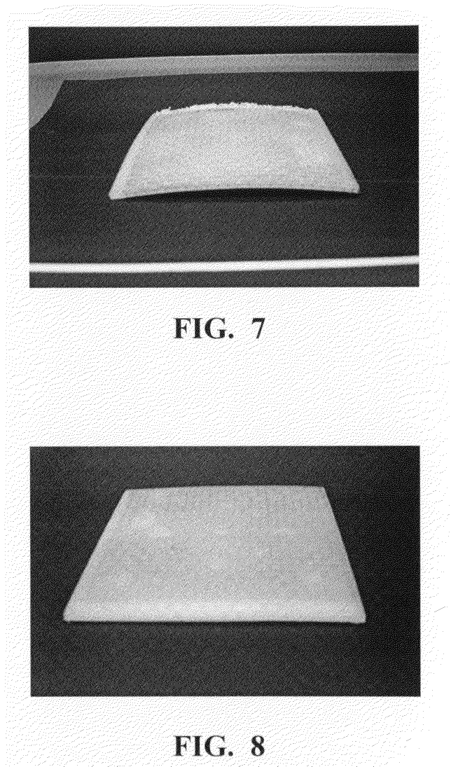

FIG. 7. is a picture of molded thermoplastic article consisting of a thermoplastic resin that is overmolded on a support screen, which support screen does not have indentations/protuberances.

FIG. 8. is a picture of molded thermoplastic article consisting of a thermoplastic resin that is overmolded on a support screen, which support screen has indentations/protuberances.

Molded articles according to the present invention are used in a variety of applications where high strength, light weight and resistance to warpage are required. By “warpage” it is meant the deformation of molded parts in one or more directions that may be caused by anisotropic shrinkage of the resin during molding or after molding. With the aim of answering such requirements, a support screen which has indentations/protuberances is overmolded with a thermoplastic resin. The indentations/protuberances serve to hold the support screen in the desired position in the mold (by bracing/fixing the mesh against the walls of the mold cavity) and to maintain it in this position during injection molding.

As already mentioned, with the aim of improving the strength and/or the resilience of a thermoplastic molded article and maximizing the anti-warping effect, a support screen is embedded in the thermoplastic resin structure. In the context of the invention, a support screen is a sheet of material having adequate holes or apertures allowing passage of molten thermoplastic polymer and capable of conferring rigidity to the finished molded article. Support screens fall into two categories: perforated sheets and interlaced filament structures.

Perforated sheets means a sheet material structure that can be a non-woven sheet, a molded or extruded polymer sheet or a metal sheet, on which surface perforations have been formed by removing parts of the material for example by cutting holes. The shape of the perforation is not limited however; it can be round holes, hexagonal holes, square holes or slotted holes.

Interlaced filaments structure means a sheet material structure that is made of filaments that are interlaced (e.g. non-woven, woven, or knitted) to form a fabric. Filaments can be made of fibers, aramids, polymers or metal.

The support screen dimensions need to be designed in a way that the holes are small enough not to detract significantly from the rigidity and strength of the final structure of the molded article but also large enough to allow the molten thermoplastic polymer to pass through the holes or the apertures during injection molding. The percentage of the area of all the holes or apertures of the total surface area of the support screen is preferably at least 30%, more preferably at least 40% and still more preferably at least 50%, and preferably less than at or about 95%.

In order to prevent that the support screen (i.e. perforated sheet or interlaced filaments) moves in the mold during injection of the molded article, the support screen is permanently deformed in a direction perpendicular to its surface at spaced intervals, i.e. indentations are made on the support screen. Indentations are made on the support screen in a direction perpendicular to its medial plane (i.e. the plane dividing horizontally the support screen into symmetrical up and down halves). The indentations can equally be described as protuberances depending on the side of the support screen that is considered. Consequently, the support screen (i.e. perforated sheet or interlaced filaments) needs to be made of a deformable material and needs also to permanently retain its shape after the process of indentation. Preferably, the support screen (i.e. perforated sheet or interlaced filaments) according to the present invention is made of metal, like for example steel, stainless steel, aluminum, copper or nickel.

In a preferred embodiment, when the support screen used in the present invention is an interlaced filament structure, it is preferably a metal mesh comprising interlaced (e.g. non-woven, woven or knitted) metal wires or filaments, wherein the metal can be for example steel, stainless steel, aluminum, copper or nickel. The metal woven wire mesh can have fixed or unfixed nodes, wherein using a metal mesh with fixed nodes has the advantage of increasing the rigidity of the final overmolded article and wherein using a metal mesh with unfixed nodes has the advantage of increasing the flex modulus of the final overmolded article. Preferably, the metal woven wire mesh for use in the present invention has unfixed nodes.

Characteristics describing the support screen (i.e. perforated sheet or interlaced filaments) used for reinforcing a molded article will depend on the thermoplastic used, like for example its melt viscosity and its density, as well as the injection molding procedure. For example, the size of the support screen holes or apertures should be larger when the polymer has a high melt viscosity. For a given thermoplastic, the number of indentations/protuberances will depend on the thickness of the support screen as well as on the size of the support screen holes. The thickness of the support screen can have any dimension, i.e. a thickness smaller than the thickness of the finished molded article. When the support screen is an interlaced filament structure, for a given size of the apertures (also named mesh size) and filament diameter, the number of indentations/protuberances will be optimized according to the melt viscosity of the thermoplastic, i.e. more indentations are required for higher melt viscosity. When the support screen is an interlaced filament structure, the ratio between the hole size and the filament diameter is preferably smaller than 8, more preferably smaller than 6 and still more preferably smaller than 4.

The configuration of the indentions on the support screen, i.e. the number of indentations and the place to make them, is determined by the overall structure of the finished overmolded article. With the aim that the thermoplastic material essentially forms a continuous matrix around the support screen that leads to the integrity of the finished molded article as well as to tightly bind the support screen inside it, indentations/protuberances are preferably made in both directions of the support screen from the medial plane (top and bottom surfaces of the support screen, see FIG. 1, where 1 is the overall thickness of the support screen, 2 is the depth of indentation on the top surface of the support screen, 3 is depth of indentation on the bottom surface of the support screen, 4 is the thickness of the support screen itself and 5 is the medial plan of the support screen). The bottom shape of the indentions is not limited however; it can be hemispherical, rhomboidal (flat) or conic (pointed). The indentations/protuberances have to be made in such a way that they extend from the top and bottom surfaces of the mesh and are spaced apart.(FIG. 2A) or may be contiguous with the indentations/protuberances extending from the opposite surface (FIG. 2B).

Indentations/protuberances in the support screen (i.e. perforated sheet or interlaced filaments) can be formed for example by punching or stamping. Indentation/protuberances can be made by using a stamp plate comprising holes that can be filled with screws (i.e. holes become bump) and a press, as described in the Examples below. After indentations have been made, the overall thickness of the support screen (FIG. 1, 1) corresponds to the whole amplitude of the indentation depth, i.e. the depth of the indention/protuberance on the top surface of the support screen (FIG. 1, 2), the depth of the indention/protuberance on the bottom surface (FIG. 1, 3) and the thickness of the support screen itself (FIG. 1, 4). The overall thickness of the support screen may vary, but it is preferable that it corresponds to the thickness of the final overmolded article or to the thickness of the mold. It means that indentations/protuberances are formed in such a way that the top of each protuberance touches the wall of the mold cavity when placed in the mold, thus fixing the support screen (i.e. perforated sheet or interlaced filaments) in place in the mold, and holding it is place during injection molding (FIG. 3). The overall shape of the support screen (i.e. perforated sheet or interlaced filaments) is preferably chosen to be the same shape as the part to be molded.

With the aim of reducing warpage of the thermoplastic molded article comprising a support screen (i.e. perforated sheet or interlaced filaments) with indentations/protuberances, it is preferred that the medial plane of the support screen reside substantially in the medial plane of the finished molded article (i.e. the plane dividing horizontally the article into symmetrical up and down halves) (FIG. 4A). This means that the surface of the support screen (i.e. the surface perpendicular to the indentations, FIG. 4A) is centered throughout the thickness of the finished molded article and that the depths of the indentations/protuberances are the same. When a higher flex modulus and a better flexural reinforcement is required, it is also possible that the medial plane of the support screen is not centered throughout the thickness of the finished molded article (FIG. 4B), meaning that the depth of the indentations is not the same on one side of the support screen as the depth of the indentations on the opposite side of the support screen.

According to another embodiment, a thermoplastic molded article comprising a support screen (i.e. perforated sheet or interlaced filaments) with indentations/protuberances may further comprise one or more additional support screens. When more than one support screen is embedded in the thermoplastic resin, preferably at least both external support screens contain indentation/protuberances that will be against the walls of the mold cavity during the injection molding of the finished article, i.e. external support screens will touch the surface of the final molded article on both sides. With the aim of maintaining all the support screens in the desired position in the mold during injection molding, adjacent support screens should be in contact to each other. The contact between adjacent support screens can be made either by making indentations/protuberances on one or both of the support screens in the direction of the other one or by adding spacers between them. Since the spacers do not only have to contain indentations/protuberances but also can be of any geometry, they can be made by any suitable material. The contact between adjacent support screens can be done either in an unfixed, non-permanent way (i.e. all the additional support screens are individually inserted in the mold cavity before injection molding) or by means of a structure comprising several support screens that are permanently joined together by any technique like for example by welding or by glue fixing them before to be inserted as a unique piece in the mold cavity.

A component of the molded article according to the present invention is any injection moldable resin, particularly thermoplastic resins. Thermoplastics are widely used for high performance applications requiring high mechanical properties, like high strength, high impact resistance, high dimensional stability, heat and chemical resistance. The thermoplastic resin for use in the present invention may be chosen, for example, from the group consisting of polyamide (nylon), polyester, liquid crystalline polymer, polyethylene, polypropylene, polyester, polystyrene, acrylonitrile butadiene styrene, polyacetal, acrylic, polycarbonate, fluoropolymer, chlorinated polymer, polysulfide, (meth)acrylic polymer, polyetherketone, polyetherimide.

In one embodiment, the molded thermoplastic article according to the present invention is made of a polyamide resin. Due to their high level of stiffness and strength, thermoplastics like fully aliphatic polyamide resins or high performance semi-aromatic polyamide resins based are excellent tools for reducing weight and system costs and for improving the reliability and performance of many structural components, which were traditionally made of metals. Examples of fully aliphatic polyamide resins useful for the present invention are poly(hexamethylene adipamide) (polyamide 66, PA66, also called nylon 66), poly(hexamethylene dodecanoamide) (polyamide 612, PA612, also called nylon 612) and are commercially available under the trademark Zytel® from E. I. du Pont de Nemours and Company, Wilmington, Del. Examples of semi-aromatic polyamide resins useful for the present invention are hexamethylene terephthalamide copolyamide (polyamide 6T, PA6T) and are commercially available under the trademark Zytel® HTN from E. I. du Pont de Nemours and Company, Wilmington, Del.

In another embodiment, the molded thermoplastic article according to the present invention is made of a thermoplastic polyester resin. Such resins are characterized by high mechanical properties combined with heat and chemical resistance which makes them suitable for high performance applications demanding dimensional and mechanical stability. Examples of polyester resins useful for the present invention are for example polyethylene terephthalate (PET), polypropylene terephthalate (PPT), polybutylene terephthalate (PBT), polycyclohexylene dimethylene terephatalate (PCT), or polynaphthalene terephthalate (PEN).

In another embodiment, the molded thermoplastic article according to the present invention is made of liquid crystalline polymer (LCP). Due to their high thermal properties and high dimensional stability, LCPs are widely used for applications requiring high temperature performance, retention of properties over a wide range of temperature, inherent flame retardancy, dimensional stability, chemical resistance and excellent electric properties, like for example for use in automotive, electrical/electronics, fiber optics and aerospace industries. By a “liquid crystalline polymer” it is meant a polymer that is anisotropic when tested using the TOT test or any reasonable variation thereof, as described in U.S. Pat. No. 4,118,372, which is hereby included by reference. Useful LCPs include polyesters, poly(ester-amides) and poly(ester-imides). Examples of liquid crystal polymer resins useful for the present invention are commercially available under the trademark Zenite® from E. I. du Pont de Nemours and Company, Wilmington, Del.

The thermoplastic resin used for making the molded article according to the present invention may further include modifiers and other ingredients, including, without limitation, lubricants, UV light stabilizers, antistatic agents, colorants (dyes, pigments or carbon black), crystallization promoting agents, plasticizers, flame retardant or oxidative stabilizers. With the aim of increasing the mechanical properties of the thermoplastic resin, inorganic fillers including glass fibers, carbon fibers, potassium titanate whiskers, wollastonite, kaolin, talc or mica can be further added, with the use of glass fibers being preferred.

Molded thermoplastic articles consisting of a thermoplastic resin overmolded on a support screen, which support screen has indentations provide a combination of impact strength, warpage resistance, toughness, chemical resistance and high temperature stability, which makes them particularly suited for demanding high performance applications, like for example, automotive and electrical/electronics applications. Example of typical automotive applications are rocker covers, front covers, oil pans, crash elements like tubes or beams or structural part like front ends, crossbeams, trunklets.

The invention will be further described in the Examples below.

### EXAMPLES

In the Examples the following materials were used to overmold the support screen according to the present invention:

PA66: commercially available from E. I. du Pont de Nemours and Company, Wilmington, Del. under the trademark Zytel®.

35% glass fiber reinforced PA6T: commercially available from E. I. du Pont de Nemours and Company, Wilmington, Del. under the trademark Zytel® HTN.

### Support Screen Preparation (Metal Woven Wire Mesh Preparation)

Stainless steel woven wire meshes having a wire diameter of 0.8 mm and a hole size (also named mesh width) of 3.15 mm were supplied in the degreased form by Haver & Boecker Wire Weaving (Germany). The grids were cut into dimension 98×98 mm and shaped using a home made press with the stamp plates illustrated in FIG. 5 such that the maximum thickness of the final molded part was equivalent to the mold cavity thickness (3.0 mm) and the medial plane of the mesh resided in the center of the mold. The number of indentations pressed into the shape was changed by adding screws 1-12 and or removing the screws A-I inserted in the stamp plates. An example of shaped metal mesh is illustrated in FIG. 6. The metal wire meshes were shaped to reside in the center of the mold and were then inserted in the open mold prior to injection.

### Molding Methods

Resins were molded into 100 mm squares test specimens of a thickness of 3 mm (100×100×3 mm) on a 175 ton injection molding machine. For PA66 based samples barrel temperature were 280-300° C., melt temperatures were 290-300° C., mold temperatures were 70-80° C. For PA6T samples barrel temperature were 315-325° C., melt temperatures were 315-325° C., mold temperatures were 140-145° C. The meshes were overmolded with PA66 or glass fiber reinforced PA6T at an injection speed of 6 mm/s.

Test specimens Test pieces having dimensions 40×100×3 mm were cut out of the original 100×100×3 mm molded plates in the flow direction and tested for tensile and impact properties.

### Mechanical Performance

The impact strength test is a method for evaluating the relative toughness of materials. It is defined as the energy per unit area required to break a test specimen by the impact of a heavy pendulum hammer. The energy lost by the pendulum is equated with the energy absorbed by the test specimen: tough materials absorb a lot of energy when fractured (meaning high values of charpy unnotched) whereas brittle materials absorb very little energy. Tensile modulus test is a method for evaluating the ability of a material to resist breaking under tensile. A high tensile modulus means that the material is rigid (more stress is required to produce a given amount of strain). Impact tests were carried out using test conditions according ISO 179/1eU and tensile tests were carried out using test conditions according to ISO 157-1/2 at 50 mm/s on the test specimens described above.

### Examples 1

No indentations were added to the steel mesh and the grid was therefore assuming a random position during overmoulding with PA66.

FIG. 7 illustrates a specimen with the mesh completely pushed to the moving side of the mold during injection and therefore resulting in high deformation and warpage of the final molded article.

### Example 2

All screws have been used in the stamp plates. The mesh was overmolded with PA66. The final parts had well centered mesh as show on FIG. 8 and were essential flat, with no visible deformation or warpage. Tensile modulus averaged on 10 test specimens was 4.8 GPa compared to 2.8 GPa for unreinforced parts containing no steel mesh. Unnotched charpy impact strength averaged on 10 test specimens was 190 kJ/m² compared to 70 kJ/m² for unreinforced parts containing no steel mesh.

### Example 3

The steel mesh was overmolded with glass fiber reinforced PA6T. The mesh was shaped the same as in Example 2. Final parts had well-centered mesh with unnotched charpy impact strengths of 145 kJ/m² as compared to 50 kJ/m² for unreinforced parts containing no steel mesh.

1. A molded thermoplastic article consisting of: a thermoplastic resin overmolded on a support screen, which support screen has indentations/protuberances.

2. The molded thermoplastic article according to claim 1, wherein the indentations/protuberances touch the surface of the article on both sides.

3. The molded thermoplastic article according to claim 1 or 2, wherein the support screen which has indentations/protuberances is a perforated sheet.

4. The molded thermoplastic article according to claim 1 or 2, wherein the support screen which has indentations/protuberances is an interlaced filament structure.

5. The molded thermoplastic article according to any preceding claim, wherein the percentage of the area of all the holes or apertures of the total surface area of the support screen is at least about 50%.

6. The molded thermoplastic article according to any preceding claim, wherein the overall thickness of the support screen corresponds to the thickness of the article.

7. The molded thermoplastic article according to any preceding claim, wherein the support screen is made of a deformable material and permanently retains its shape after the process of indentation.

8. The molded thermoplastic article according to any preceding claim, further comprising one or more additional support screens.

9. The molded thermoplastic article according to any preceding claim, where the thermoplastic resin polymer is chosen among polyamide (nylon), polyester, liquid crystalline polymer, polyethylene, polypropylene, polyester, polystyrene, acrylonitrile butadiene styrene, polyacetal, acrylic, polycarbonate, fluoropolymer, chlorinated polymer, polysulfide, (meth)acrylic polymer, polyetherketone or polyetherimide.

10. The molded thermoplastic article according to any preceding claim, wherein the support screen is made of metal.

11. The molded thermoplastic article according to claim 10, wherein the support screen is a metal mesh comprising interlaced metal wires or filaments.

12. A method for manufacturing a reinforced thermoplastic article, the method comprising the steps of:
a) providing an injection mold having a cavity;
b) placing a support screen having indentations/protuberances, which indentations/protuberances touch the inner surface of the injection mold cavity on both sides in an injection mold so as to hold the support screen in the desired position in the mold, and
c) injection molding the thermoplastic material to engulf and embed the support screen.

13. The method for manufacturing a reinforced thermoplastic article according to claim 12, further comprising an additional step which takes place before steps a) and b) and which is the indentation of the support screen.

14. The method for manufacturing a reinforced thermoplastic article according to claim 12 or 13, wherein the support screen having indentations/protuberances is a perforated sheet.

15. The method for manufacturing a reinforced thermoplastic article according to claim 12 or 13, wherein the support screen which has indentations/protuberances is an interlaced filament structure.

16. The method for manufacturing a reinforced thermoplastic article according to any one of claims 12 to 15, wherein the percentage of the area of all the holes or apertures in the total surface of the support screen is at least about 50%.

17. The method for manufacturing a reinforced thermoplastic article according to any one of claims 12 to 16, wherein the overall thickness of the support screen corresponds to the thickness of the article.

18. The method for manufacturing a reinforced thermoplastic article according to any one of claims 12 to 17, wherein the support screen is made of a deformable material and permanently retains its shape after the process of indentation.

19. The method for manufacturing a reinforced thermoplastic article according to any one of claims 12 to 18, wherein the article further comprise one or more additional support screens.

20. The method for manufacturing a reinforced thermoplastic article according to any one of claims 12 to 19, where the thermoplastic resin polymer is chosen among polyamide (nylon), polyester, liquid crystalline polymer, polyethylene, polypropylene, polyester, polystyrene, acrylonitrile butadiene styrene, polyacetal, acrylic, polycarbonate, fluoropolymer, chlorinated polymer, polysulfide, (meth)acrylic polymer, polyetherketone or polyetherimide.

21. The method for manufacturing a reinforced thermoplastic article according to any one of claims 12 to 20, wherein the support screen is made of metal.

22. The method manufacturing a reinforced thermoplastic article according to claim 21, wherein the support screen is a metal mesh comprising interlaced metal wires or filaments.
